(19) United States
(12) Patent Application Publication
(10) Pub. No.: US 2002/0134254 A1
(43) Pub. Date: Sep. 26, 2002

(54) Apparatus for extracting liquid from a composite mass

(76) Inventors: Brent H. Sebright, Hopkins, MI (US); Stuart L. Sebright, Allegan, MI (US)

Correspondence Address: MCGARRY BAIR LLP, 171 MONROE AVENUE, SUITE 600, GRAND RAPIDS, MI, 49503, US

(21) Appl. No.: 09/681,369

(22) Filed: Mar. 26, 2001

(51) Int. Cl. B30B 9/06

(52) U.S. Cl. 100/127

(57) ABSTRACT

An apparatus for removing liquid from a composite mixture of liquid and solids comprises a hopper mounted atop a compactor ram assembly. A snout section and an extruder section are mounted axial to the compactor ram assembly. A hydraulically-operated ram compresses wet material into the snout and extruder sections. Under pressure from the ram, liquid in the waste material escapes from drainage holes in the snout section top, bottom, and sides, and the extruder section top, bottom, and sides. A platen, pivotally mounted to the extruder top plate near the exit of the device and biased with a constant pressure, controls the back pressure in the extruder and snout sections. The apparatus has an extruder section and snout section of the same constant cross section and coaxial with each other. In a second embodiment of the apparatus, certain of the walls may diverge to further facilitate access to the first platen through the exit opening.

### BACKGROUND OF INVENTION

1. Field of the Invention

This invention relates to compression-operated liquid extraction devices. It is specifically directed to an improved design of the extruder section.

2. Description of Related Art

Batch process, compression-driven liquid extraction devices for dewatering waste material have been well known for many years. The material to be dewatered is a composite mass of liquid and solids which the device compresses to remove much of the liquid, leaving a drier product more suitable for land fill. The liquid in the material to be dewatered is typically not just water but also may include oils, greases, solvents and other liquids. Typical liquid and solid mixtures that require dewatering include paper pulp, garbage, animal hair and follicle solvent from leather manufacture, animal by-products, dairy products, and other wet waste products. The input composite material is typically 5%-15% solids.

U.S. Pat. No. 5,215,007 to Sebright, et al. entitled Apparatus for Extracting Liquid from a Composite Mass and which is incorporated herein by reference, discloses a liquid extraction device that utilizes an extruder section with a bottom wall that is inclined upwardly at an angle from a defined axis and side walls that converge toward the discharge end. The inclined bottom wall enables gravity to assist the end platen in maintaining sufficient compression of the dewatered solids at the discharge end. The output dewatered material from this device can typically be 54% or higher solids, greatly exceeding the dewatering capacity of previous known devices. However, it has been found that an inclined bottom wall and converging side walls inhibit expeditious repair of the main ram. Moreover, any convergence in the extruder sometimes increases friction between the dewatered solids and the extruder walls to an unacceptable degree.

### SUMMARY OF INVENTION

An improved design of an apparatus for extracting liquid from a composite mass of liquids and solids according to the invention comprises a housing and an extruder connected to the housing. The housing has a cavity which is open at one end of the housing. An axis is defined in the housing which extends through the cavity and the open end. The extruder is connected to the housing at the open end and has opposed top and bottom walls and opposed side walls. The top, bottom, and side walls thereby define a channel which has a longitudinal axis that is colinear with the cavity axis. The channel extends to an exit opening from the extruder. Each of the walls of the extruder has a matrix of apertures extending therethrough.

A first platen is mounted within the housing for movement from a retracted position adjacent the cavity and through the cavity and along the axis to an extended position near the open end of the housing. The platen may also have a matrix of apertures extending through it. A power cylinder is operably connected to the first platen to cause it to move to and from the extended position.

A second platen is mounted to one of the extruder walls near the exit opening for pivotable movement inwardly of the channel. The second platen is preferably configured to restrict the cross-sectional area of the channel. The second platen is biased to maintain it inwardly of the channel against a predetermined pressure. Thus, a composite mass introduced into the cavity of the housing is compressible within the cavity and the channel between the first and second platens. The pressure introduced to the mass by action of the first platen moving to an extended position causes liquid within the mass to be forced through the apertures. When the pressure in the mass exceeds a predetermined pressure, the mass is caused to move through the exit opening for subsequent disposal.

None of the extruder walls converge toward the longitudinal axis. Thus, it is possible to remove the first platen through the extruder for repair. Preferably, at least one of the extruder walls diverges so that the cross-sectional area of the channel near the housing is less than the cross-sectional area of the channel away from the housing. Typically, the amount of divergence is approximately 1 inch in 10 feet.

### BRIEF DESCRIPTION OF DRAWINGS

The invention will now be described with reference to the following drawings wherein:

FIG. 1 is a left side elevation of an embodiment of a dewatering device according to the invention;

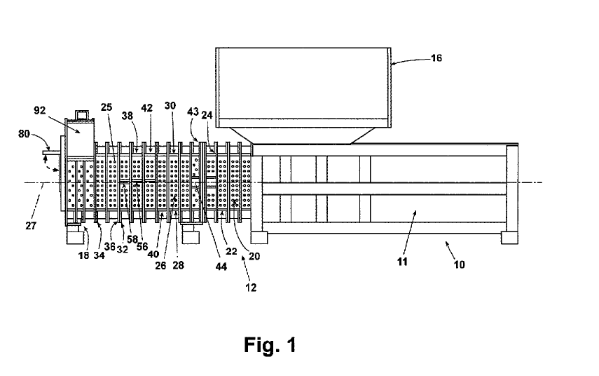

FIG. 2 is a plan view of the dewatering device of FIG. 1; and

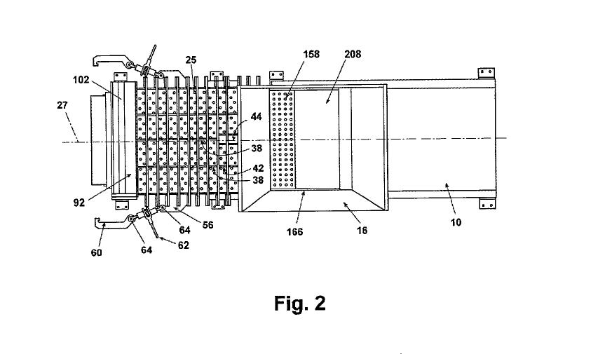

FIG. 3 is a partial side elevation of the dewatering device of FIG. 1 showing the plenum section.

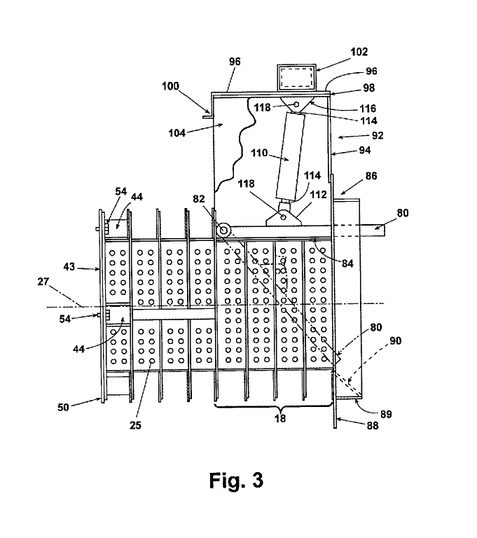

### DETAILED DESCRIPTION

U.S. Pat. No. 5,215,007 to Sebright, et al., entitled Apparatus for Extracting Liquid from a Composite Mass (the Sebright “007 patent) is incorporated herein by reference, and discloses an apparatus that in all respects is equivalent to the invention claimed herein except for the extruder section and snout section. Reference should be made to the Sebright “007 patent for details of the general structure and operation of the invention, except as otherwise set forth herein.

Referring now to the drawings, and to the Sebright “007 patent, it can be seen that an apparatus for extracting liquid from a composite mass as claimed herein comprises generally a hopper 16 mounted atop a horizontal compactor ram assembly 10, having a snout section 12, an extruder section 14, and an extruder plenum assembly 18 mounted in an axial direction to the compactor ram assembly 10.

In accordance with the invention, the snout section 12 is a generally rectangular shaped horizontal duct comprised of two parallel rectangular snout side plates 20, a rectangular snout bottom plate 22, normal to the face of the snout side plates 20, and a parallel rectangular snout top plate 24, which define a longitudinal axis of symmetry 27. The snout side plates 20, the snout bottom plate 22, and the snout top plate 24 are penetrated by a matrix of small drainage holes 25 which permit the liquid to escape during the dewatering process. The extruder section 14 is similarly constructed, having extruder side plates 26, an extruder bottom plate 28 and an extruder top plate 30 all of which are also penetrated by drainage holes 25, and which also define the longitudinal axis 27. The longitudinal axis 27 is also collinear with the cavity axis extending through the cavity within the housing 11 in the Sebright “007 patent.

The preferred embodiment of the invention employs an extruder section 14 which is coaxial with the snout section 12 about the longitudinal axis 27. The extruder section 14 and the snout section 12 together define a channel extending from the cavity to the exit opening. The extruder top plate 30 and the extruder bottom plate 28 are oriented horizontally, with the edges of the top and bottom plates connecting to the extruder plenum 18 at the same elevations as the correlating edges of the snout section 12, so that the extruder top plate 30 is coplanar with the snout top plate 24, and the extruder bottom plate 28 is coplanar with the snout bottom plate 22. The extruder side plates 26 are oriented parallel to each other, with each extruder side plate 26 coplanar with the corresponding snout side plate 20 to which it is connected. Alternatively, the extruder top plate 30 and snout top plate 24 may be replaced by a single top plate of the same width and equal to the combined length of the top plates 30, 24, and the bottom and side plates similarly replaced, to provide an undivided channel section rather than separate extruder and snout sections.

In an alternative embodiment, the invention may employ a diverging extruder section in which one or more of the extruder plates diverge from the longitudinal axis 27 in the direction of the discharge end.

While particular embodiments of the invention have been shown, it will be understood, of course, that the invention is not limited thereto since modifications may be made by those skilled in the art, particular in light of the foregoing teachings. Reasonable variation and modification are possible within the foregoing disclosure of the invention without departing from the scope of the invention.

1. In an apparatus for extracting liquid from a composite mass of liquid and solids, said apparatus comprising:
a housing having a cavity open at one end with an axis extending through the cavity;
a first platen mounted within the housing for movement from a retracted position away from the open end, along the cavity axis, to an extended position near the open end;
a power cylinder operably connected to the first platen to cause movement thereof;
an extruder connected to the housing at the open end and having opposed top and bottom walls and opposed side walls, said top, bottom, and side walls defining a channel with a longitudinal axis co-linear with the cavity axis, the extruder extending to an exit opening, each of said walls having a matrix of apertures therethrough;
a second platen mounted to one of said extruder walls near the exit opening for pivotable movement inwardly of the channel, the second platen being configured to restrict the cross-sectional area of the channel; and
biasing means connected to the second platen for maintaining the second platen inwardly of the channel against a predetermined pressure;
the composite mass being compressible within the cavity and the channel and between the first and second platens whereby to extract liquid therefrom and force it through the apertures and further whereby to move the remaining mass through the exit opening when the pressure of the composite mass exceeds the predetermined pressure, the improvement wherein:
none of the top, bottom, and side walls converges toward the longitudinal axis whereby to enable removal of the first platen through the exit opening for repair.

2. The apparatus of claim 1 wherein the bottom wall is parallel to the longitudinal axis.

3. The apparatus of claim 2 wherein the top and side walls diverge from the longitudinal axis.

4. The apparatus of claim 1 wherein three of the walls diverge from the longitudinal axis.

5. The apparatus of claim 1 wherein all of the walls diverge from the longitudinal axis.
